(19) United States
(12) Patent Application Publication
(10) Pub. No.: US 2026/0351594 A1
(43) Pub. Date: Nov. 5, 2026

(54) TERNARY CATHODE MATERIAL AND PREPARATION METHOD THEREOF, AND LITHIUM-ION BATTERY

(71) Applicant: GUANGDONG BRUNP RECYCLING TECHNOLOGY CO., LTD., Foshan (CN)

(72) Inventors: Changdong LI, Foshan (CN); Haijun YU, Foshan (CN); Yinghao XIE, Foshan (CN)

(73) Assignee: GUANGDONG BRUNP RECYCLING TECHNOLOGY CO., LTD., Foshan (CN)

(21) Appl. No.: 19/572,749

(22) Filed: Mar. 19, 2026

Related U.S. Application Data
(63) Continuation of application No. PCT/CN2025/130875, filed on Oct. 29, 2025.

(30) Foreign Application Priority Data
Apr. 18, 2025 (CN) 202510487817.4

(51) Int. Cl. H01M 4/525; C01G 53/506; H01M 10/0525

(52) U.S. Cl. CPC H01M 4/525; C01G 53/506; H01M 10/0525; C01P 2002/50; C01P 2004/03; C01P 2006/40

(57) ABSTRACT

The application provides a positive electrode plate, a secondary battery, a preparation method of the positive electrode plate, a battery module comprising the secondary battery, a battery pack and an electric device. The positive electrode sheet comprises a positive electrode current collector, a positive electrode active material layer arranged on at least one surface of the positive electrode current collector, and a lithium supplementing layer arranged on the surface of the positive electrode active material layer opposite to the positive electrode current collector, wherein the lithium supplementing layer comprises a positive electrode lithium supplementing material, a conductive agent and a binder A, the positive electrode lithium supplementing material comprises a lithium-rich metal oxide, the binder A is selected from polymers comprising a first monomer unit shown in a formula I and a second monomer unit shown in a formula II, and R is a metal oxide 1, R2, R3, R4, R5 And R is 6 Each independently selected from hydrogen or substituted or unsubstituted C1-C8 alkyl, R is selected from substituted or unsubstituted C1-C8 alkyl.

### CROSS-REFERENCE TO RELATED APPLICATIONS

This application is a continuation of International Application No. PCT/CN2025/130875, filed on Oct. 29, 2025, which claims priority to Chinese Patent Application No. 2025104878174, filed on Apr. 18, 2025. All of the aforementioned applications are incorporated herein by reference in their entireties.

### TECHNICAL FIELD

The present disclosure relates to the technical field of cathode materials, and in particular to a ternary cathode material and a preparation method thereof, and a lithium-ion battery.

### BACKGROUND

The ternary cathode material, LiNiₓCo_{y}Mn_{z}O₂ (x≥0.6) has advantages of high capacity, low cost, and scalable production, etc., making it one of the most promising cathode materials for high-specific-energy lithium-ion batteries. During cycling, a polycrystalline ternary cathode material may undergo fracture due to electrochemical-mechanical coupling, with fractures predominantly occurring at the grain boundaries. Crack formation occurs when an accumulated stress exceeds a yield limit of the particles, leading to crack formation at the grain boundaries of the grains. During the cycling process, the cracks gradually extend from the interior of the secondary particles to the surface, even leading to particle pulverization.

The microcracks of the ternary cathode material provide channels for the electrolyte to infiltrate into the interior of the secondary particles, intensifying side-reactions between the interior of the material and the electrolyte. This causes the highly active Ni⁴⁺ on the surface of the material within the particles to react and form a rock-salt phase of NiO, which not only consumes the electrolyte and active material, but also creates regions of electronic and ionic isolation within the particles, increasing the resistance of the material and accelerating the capacity fade during cycling. In addition, the anisotropic volume contraction and expansion occurring of primary particles during the charging and discharging process exert a considerable impact on the stress accumulation and yield limit within the secondary particles.

Therefore, there is an urgent need to provide a ternary cathode material that can mitigate stress fatigue, to reduce the generation of microcracks and improve the cycling performance of the battery.

To this end, the present disclosure is proposed hereby.

### SUMMARY

The objective of the present disclosure is to provide a ternary cathode material and a preparation method thereof, and a lithium-ion battery, which is intended to reduce the generation of microcracks in the cathode material and improve the cycling performance of the battery.

The present disclosure is achieved as follows.

In a first aspect, the present disclosure provides a ternary cathode material, which satisfies:

$$F = \frac{{\sum }_{1}^{n} ( \frac{{d}_{r}}{{d}_{R}} \times θ )}{n} \times ( \frac{Dv 90 - Dv max}{Dv max - Dv 10} ) \times [ 1000 \times {( ε - 0.25 )}^{2} + 0 \text{.1} ] ;$$

0.5°≤F≤40°;
where, F denotes a structural stability parameter of the ternary cathode material, in a unit of °;
dᵣ denotes a maximum Feret diameter of a primary particle cross-section of a primary particle within a secondary particle cross-section of the ternary cathode material, in a unit of μm;
d_{R} denotes a diameter of a minimum circumcircle of the secondary particle cross-section that contains the corresponding primary particle, in a unit of μm;
θ denotes an angle between a radius at a direction of the minimum circumcircle of the secondary particle cross-section passing through a midpoint of the maximum Feret diameter of the primary particle cross-section in the secondary particle cross-section and the maximum Feret diameter of the primary particle cross-section oriented toward a direction with a shorter distance to the minimum circumcircle, in a unit of °;
ε denotes a porosity, and

$$ε = \frac{ρ - CD}{ρ} ,$$

ρ denotes a true density, CD denotes a compaction density, and both ρ and CD are in g/cm³;
Dv90 and Dv10 respectively denote particle sizes at which a cumulative volume of the ternary cathode material particles in a corresponding batch reaches 90% and 10%, Dvmax is a particle size corresponding to a maximum y value on a corresponding particle size distribution curve, and Dv90, Dv10, Dvmax are all in μm;
n denotes a number of primary particles selected from the same or different secondary particles, and n≥40.

In alternative embodiments, the ternary cathode material satisfies at least one of the following features A1 to K1:

$$0.1 \leq \overline{( \frac{{d}_{r}}{{d}_{R}} )} \leq 1. ; \qquad Feature A 1$$

Feature B1: 0°≤θ̅≤70°;

$$0.5 ° \leq \frac{{\sum }_{1}^{n} ( \frac{{d}_{r}}{{d}_{R}} \times θ )}{n} \leq 20 ° ; \qquad Feature C 1$$

$$0.5 \leq \frac{D v 90 - Dv max}{Dv max - Dv 10} \leq 20 ; \qquad Feature D 1$$

Feature E1: 0.1≤[1000× (ε−0.25)²+0.1]≤6.5;

$${d}_{r} \leq 5 μ m , 2 μ m \leq {d}_{R} \leq 25 μ m , 0.05 \leq \frac{{d}_{r}}{{d}_{R}} \leq 0.5 ; \qquad Feature F 1$$

Feature G1: 0°≤θ≤110°;
Feature H1: 0.1≤ε≤0.4;
Feature I1: 3 μm≤Dvmax≤15 μm, 6 μm≤Dv90≤25 μm, 2 μm≤Dv10≤8 μm;
Feature J1: 4.4 g/cm³≤ρ≤5.1 g/cm³, and 3.15 g/cm³≤CD≤3.85 g/cm³;
K1: a selection of n primary particles should satisfy the following conditions:

$$\frac{{d}_{r}}{{d}_{R}} < 0.1 and 0.1 \leq \frac{{d}_{r}}{{d}_{R}} ,$$

and a number of primary particles with

$$\frac{{d}_{r}}{{d}_{R}} < 0.1$$

selected is 2.5-3.5 times a number of primary particles with

$$0.1 \leq \frac{{d}_{r}}{{d}_{R}}$$

selected.

In a second aspect, the present disclosure further provides a preparation method of a ternary cathode material including: subjecting a cobalt source, a nickel source, and a manganese source to a co-precipitation reaction to obtain a precursor intermediate;
adjusting a pH of the precursor intermediate to 8-9, followed by mixing and reaction with a directing agent, and then with an initiator, thereafter raising the pH and allowing a cobalt source, a nickel source, and a manganese source to continue the co-precipitation reaction, and then performing solid-liquid separation to obtain a precursor; and
mixing the precursor with a lithium source and then calcining.

In alternative embodiments, a process of preparing the precursor using the precursor intermediate satisfies at least one of the following features A2 to E2:
Feature A2: the directing agent is at least one selected from the group consisting of allylphosphonic acid monoammonium salt, vinyl phosphoric acid, cis-propenyl phosphoric acid, and allyl phosphoric acid;
Feature B2: the directing agent is controlled to be added at a concentration of 0.7 mol/L to 1.0 mol/L;
Feature C2: the reaction with the directing agent is carried out at a temperature of 15° C. to 35° C. for 1.5 h to 2.5 h;
Feature D2: during the reactions with the directing agent and the initiator, ultrasonic oscillation is applied at a frequency of 15 kHz to 30 kHz;
Feature E2: an acid solution is used to adjust the pH of the precursor intermediate to 8-9, and the acid solution is at least one selected from the group consisting of sulfuric acid solution, acetic acid solution, and citric acid solution.

In alternative embodiments, the process of preparing the precursor using the precursor intermediate satisfies at least one of the following features A3 to D3:
Feature A3: the initiator is at least one selected from the group consisting of 2,2-azobis(2-methylpropylamidine) dihydrochloride and azodiisobutylamidine hydrochloride;
Feature B3: the initiator is controlled to be added at a concentration of 4 g/L to 6 g/L;
Feature C3: the reaction with the initiator is carried out at a temperature of 15° C. to 35° C. for 1.5 h-2.5 h;
Feature D3: After the reaction with the initiator is completed, the pH is raised to 11.0-11.5, and a mixed nickel-cobalt-manganese salt solution, a precipitant solution and a complexing agent solution are introduced for the co-precipitation reaction for 6 h-20 h, and then a resulting reaction solution is subjected to solid-liquid separation, washing, and drying to obtain the precursor.

In alternative embodiments, a process of preparing the precursor intermediate includes: introducing a mixed nickel-cobalt-manganese salt solution, a precipitant solution and a complexing agent solution into a reaction kettle containing a base solution to allow reaction under stirring for 2 h-3 h; wherein the mixed nickel-cobalt-manganese salt solution is obtained by mixing a nickel source, a cobalt source, and a manganese source, and a molar ratio of nickel, cobalt, and manganese is 5:2:3, 1:1:1, 4:2:4, 6:2:2, 8:1:1 or 86-96:2-9:2-5;
and/or, during the process of preparing the precursor intermediate, a reaction temperature is controlled at 45° C. to 60° C., and a stirring speed is controlled to be 400 rpm to 700 rpm.

In alternative embodiments, the process of preparing the precursor intermediate satisfies at least one of the following features A4 to C4:
Feature A4: a concentration of the mixed nickel-cobalt-manganese salt solution is 1.5 mol/L to 2.2 mol/L, and a feed rate of the mixed nickel-cobalt-manganese salt solution is 25 mL/min to 35 mL/min;
Feature B4: the precipitant solution is a sodium hydroxide solution with a concentration of 10 mol/L to 12 mol/L, and a pH of the solution in the reaction kettle is maintained at 11.0 to 11.5 by adjusting a feed rate of the sodium hydroxide solution;
Feature C4: the complexing agent solution is an aqueous ammonia solution, and an ammonia concentration of the solution in the reaction kettle is kept at 0.7 mol/L to 1.1 mol/L by adjusting a feed rate of the aqueous ammonia solution.

In alternative embodiments, the precursor is mixed with a lithium source and then subjected to a two-step calcination to obtain a ternary cathode material intermediate; and
the ternary cathode material intermediate is mixed with a coating agent and then calcined.

In alternative embodiments, a process of preparing the ternary cathode material using a precursor satisfies at least one of the following features A5 to G5:
Feature A5: the two-step calcination includes: first maintaining a temperature at 400° C. to 550° C. for 3 h-5 h, and then raising the temperature to 750° C. to 800° C. and maintaining the temperature for 12 h-15 h;
Feature B5: a molar ratio of lithium to a total amount of nickel, cobalt and manganese is controlled to be 1.03-1.07:1;
Feature C5: the precursor and the lithium source are mixed, ground and then subjected to a two-step calcination;
Feature D5: the lithium source is at least one selected from the group consisting of lithium hydroxide, lithium carbonate, and lithium oxalate;
Feature E5: the coating agent is at least one selected from the group consisting of V₂O₅, Al₂O₃, ZrO₂, TiO₂, SnO₂, ZnO, MgO, RuO₂, La₂O₃, CeO₂, Co₃O₄, SiO₂, FePO₄, Li₃PO₄, Li₂MnO₃, LiAlO₂, Li₂TiO₃, Li₂ZrO₃, Li₃VO₄, Li₂SiO₃, AlF₃, LaF₃, and MgF₂;
Feature F5: a mass ratio of the coating agent to the ternary cathode material intermediate is 5-10:100;
Feature G5: the calcination of the ternary cathode material intermediate and the coating agent is carried out at a temperature of 550° C. to 650° C. for 3 h to 8 h.

In a third aspect, the present disclosure further provides a lithium-ion battery, including the ternary cathode material provided in any of the above embodiments or the ternary cathode material prepared by the preparation method provided in any of the above embodiments.

The present disclosure has the following beneficial effects: due to the fact that a polycrystalline ternary cathode material is composed of secondary particles assembled from a plurality of primary particles, a size dᵣ of primary particles, an arrangement angle θ, a porosity ε, and a distribution proportion

$$( \frac{Dv 90 - Dvmax}{Dvmax - Dv 10} )$$

of large and small particles in the ternary cathode material have a significant impact on the internal stress accumulation and yield limit of the secondary particles caused by the anisotropic volume contraction and expansion during the charging and discharging process of primary particles. The above product parameters have coordinated impacts on each other. By using the above parameters to construct an expression for a structural stability parameter F of the ternary cathode material, and making F satisfy a specific range, the structural stability of the ternary cathode material can be improved, stress fatigue can be mitigated, and the formation of microcracks can be reduced, thereby improving the cycling performance of the battery.

### BRIEF DESCRIPTION OF THE DRAWINGS

In order to more clearly explain the technical schemes of the embodiments of the present disclosure, a brief introduction will be given below to the accompanying drawings required to be used in the embodiments. It should be understood that the following accompanying drawings only illustrate certain embodiments of the present disclosure, and therefore should not be regarded as limitations on the scope. For those having ordinary skills in the art, other relevant accompanying drawings can also be obtained based on these drawings without creative efforts.

FIG. 1 shows an SEM cross-sectional image of secondary particles of a ternary cathode material provided in Example 1 of the present disclosure.

FIG. 2 shows an SEM cross-sectional image of secondary particles of a ternary cathode material provided in Comparative Example 1 of the present disclosure.

FIG. 3 shows a schematic diagram of primary particles, secondary particles, dᵣ, dᵣ and θ in a product of the present disclosure.

### DETAILED DESCRIPTION OF THE EMBODIMENTS

To make the objectives, technical schemes, and advantages of the embodiments of the present disclosure clearer, the technical schemes in the embodiments of the present disclosure will be clearly and completely described below. For conditions not specifically indicated in the embodiments, the experiments shall be conducted in accordance with conventional conditions or conditions recommended by the manufacturer. For reagents or instruments whose manufacturers are not indicated, they are all commercially available conventional products.

In order to better evaluate the performance of a ternary cathode material in resisting stress fatigue and provide a ternary cathode material with high cycling performance and low capacity fade rate, the present disclosure constructs an expression for a structural stability parameter F of the ternary cathode material by integrating parameters such as a size dᵣ of primary particles, an arrangement angle θ, a porosity ε, and a distribution proportion

$$( \frac{Dv 90 - Dvmax}{Dvmax - Dv 10} )$$

of large and small particles in the ternary cathode material. The value of F is adjusted by regulating the structure of the ternary cathode material.

The expression for the structural stability parameter F of the ternary cathode material is as follows:

$$F = \frac{{\sum }_{1}^{n} ( \frac{{d}_{r}}{{d}_{R}} \times θ )}{n} \times ( \frac{Dv 90 - Dvmax}{Dvmax - Dv 10} ) \times [ 1000 \times {( ε - 0.25 )}^{2} + 0.1 ] .$$

The ternary cathode material provided in the embodiments of the present disclosure satisfies 0.5°≤F≤40°, for example, F may be 0.5°, 1.0°, 3.0°, 5.0°, 8.0°, 10.0°, 13.0°, 15.0°, 18.0°, 20.0°, 23.0°, 25.0°, 28.0°, 30.0°, 33.0°, 35.0°, 38.0°, 40.0°, etc. F is in a unit of °.

The parameters in the expression for the structural stability parameter F of the ternary cathode material are explained as follows:
dᵣ denotes a maximum Feret diameter of a primary particle cross-section of a primary particle within a secondary particle cross-section of the ternary cathode material (hereinafter referred to as diameter), in a unit of μm; d_{R} denotes a diameter of a minimum circumcircle of the secondary particle cross-section that contains the corresponding primary particle (hereinafter referred to as diameter), in a unit of μm.

$$\frac{{d}_{r}}{{d}_{R}}$$

denotes a relative size of the primary particles to the secondary particles, and the larger the value, the greater the impact of the stress accumulation of the primary particles on the secondary particles.
θ denotes an angle between a radius at a direction of the minimum circumcircle of the secondary particle cross-section passing through a midpoint of the maximum Feret diameter of the primary particle cross-section in the secondary particle cross-section and the maximum Feret diameter of the primary particle cross-section oriented toward a direction with a shorter distance to the minimum circumcircle, in a unit of °. θ denotes a deviation angle of the radial arrangement of the primary particles in the secondary particles, the larger the deviation angle, the less conducive it is for stress relief, leading to stress concentration.

Specifically, dᵣ, d_{R} and θ are obtained by analyzing scanning electron microscopy (SEM) images of cross-sections of the cathode material using ImageJ, the detailed testing process can be found in the specific examples hereinafter.
ε a denotes a porosity, an increase in this value indicates more voids among particles, which is conducive to stress relief. However, if the value is too large, there are too many voids, which is not conducive to the structural stability of the secondary particles,

$$ε = \frac{ρ - CD}{ρ} ,$$

where ρ denotes a true density, CD denotes a compaction density, and both ρ and CD are in g/cm³. The porosity ε can be calculated by measuring the true density and compaction density.
Dv90 and Dv10 respectively denote particle sizes at which a cumulative volume of the ternary cathode material particles in a corresponding batch reaches 90% and 10%, Dvmax is a particle size corresponding to a maximum y value on a corresponding particle size distribution curve, and Dv90, Dv10, Dvmax are all in μm. Dv90, Dv10, Dvmax are obtained by a laser particle size analyzer. Dvmax refers to a particle size corresponding to the maximum y value on a particle size distribution curve of the normal distribution, whose value is generally less than Dv90.

$$( \frac{Dv 90 - Dvmax}{Dvmax - Dv 10} )$$

denotes a distribution proportion of large and small particles on both sides of the particle size, Dvmax on the particle size distribution curve. The larger the secondary particles, the more likely they are to generate concentrated stress and exceed the yield limit, leading to fracture.
n denotes a number of primary particles selected from the same or different secondary particles, and n≥40, for example, it may be 40, 60, 80, 100, 120, 150, 180, 200, etc. The number may also be greater to improve the accuracy of the measurement. In further embodiments, the selection of n primary particles should satisfy the following conditions:

$$\frac{{d}_{r}}{{d}_{R}} < 0.1 and 0.1 \leq \frac{{d}_{r}}{{d}_{R}} ,$$

and a number of primary particles with

$$\frac{{d}_{r}}{{d}_{R}} < 0.1$$

selected is 2.3-3.5 times, such as 2.5 times, 2.8 times, 3.0 times, 3.2 times, 3.5 times, etc., a number of primary particles with

$$0.1 \leq \frac{{d}_{r}}{{d}_{R}}$$

selected.

It should be noted that due to the fact that the polycrystalline ternary cathode material is composed of secondary particles assembled from a plurality of primary particles, the size dᵣ of primary particles, the arrangement angle θ, the porosity ε, and the distribution proportion

$$( \frac{Dv 90 - Dvmax}{Dvmax - Dv 10} )$$

of large and small particles in the ternary cathode material have a significant impact on the internal stress accumulation and yield limit of the secondary particles caused by the anisotropic volume contraction and expansion during the charging and discharging process of primary particles. In addition, the above product parameters have coordinated impacts on each other. For particles with determined

$$\frac{{d}_{r}}{{d}_{R}}$$

value, a large θ is unfavorable for stress relief, while a small θ is relatively favorable for stress relief. A small ε is unfavorable for stress relief, while a large ε is relatively favorable for stress relief. However, an excessively high ε leads to capacity loss and is detrimental to structural stability. Moreover,

$$( \frac{Dv 90 - Dvmax}{Dvmax - Dv 10} )$$

reflects the proportion of large and small particles in the secondary particles. A higher value indicates a greater fraction of larger particles in the secondary particles, making them more prone to fracture. In view of the foregoing, when F is within the specified range, the structural stability of the ternary cathode material is relatively optimal.

In some embodiments, it is preferable to control the parameters in the expression for the structural stability parameter F of the ternary cathode material within a certain range:

$$0.1 \leq \overline{( \frac{{d}_{r}}{{d}_{R}} )} \leq 1. , wherein \overline{( \frac{{d}_{r}}{{d}_{R}} )}$$

denotes an average value of

$$\frac{{d}_{r}}{{d}_{R}}$$

selected from testing all selected particles, and the value of

$$\overline{( \frac{{d}_{r}}{{d}_{R}} )}$$

may be 0.1, 0.3, 0.5, 0.8, 1.0, etc. If the value of

$$\overline{( \frac{{d}_{r}}{{d}_{R}} )}$$

is too large, the stress accumulation of the primary particles will have too great impact on the secondary particles, which is detrimental to obtaining a ternary cathode material capable of resisting stress fatigue.

0°≤θ̅≤70°, wherein θ̅ denotes an average value of θ obtained from testing all selected particles, and the average value may be 0°, 5°, 10°, 20°, 30°, 40°, 50°, 60°, 70°, etc.

$$0.5 ° \leq \frac{{\sum }_{1}^{n} ( \frac{{d}_{r}}{{d}_{R}} \times θ )}{n} \leq 20 ° ,$$

wherein when the value of

$$\frac{{\sum }_{1}^{n} ( \frac{{d}_{r}}{{d}_{R}} \times θ )}{n}$$

is within this range, it is more favorable for stress relief, and the specific value may be 0.5°, 1.0°, 3.0°, 5.0°, 8.0°, 10.0°, 13.0°, 15.0°, 18.0°, 20.0°, etc.

$$0.5 \leq \frac{Dv 90 - Dvmax}{Dvmax - Dv 10} \leq 20 , wherein \frac{Dv 90 - Dvmax}{Dvmax - Dv 10}$$

may reflect the proportion of large and small particles in the secondary particles. If the value is too large, the secondary particles are more prone to fracture. Specifically, the value of

$$\frac{Dv 90 - Dvmax}{Dvmax - Dv 10}$$

may be 0.5, 1.0, 3.0, 5.0, 8.0, 10.0, 13.0, 15.0, 18.0, 20.0, etc.

0.1≤[1000×(ε−0.25)²+0.1]≤6.5, wherein if the value of [1000×(ε−0.25)²+0.1] is too large, it will affect the structural stability, and if the value is too small, it is also unfavorable for stress relief. Specifically, the value of [1000×(ε−0.25)²+0.1] may be 0.10, 0.50, 1.00, 2.00, 3.00, 4.00, 5.00, 6.00, 6.50, etc.

dᵣ≤5 μm, 2 μm d_{R}≤25 μm, and

$$0.05 \leq \frac{{d}_{r}}{{d}_{R}} \leq 0.5 .$$

values or dᵣ, d_{R}, and

$$\frac{{d}_{r}}{{d}_{R}}$$

within the above range are more favorable for stress relief. Specifically, the value of dᵣ may be 0.1 μm, 0.5 μm, 1.0μ, 2.0 μm, 3.0 μm, 4.0 μm, 5.0 μm, etc.; the value of d_{R} may be 2 μm, 5 μm, 8 μm, 10 μm, 13 μm, 15 μm, 18 μm, 20 μm, 23 μm, 25 μm, etc.; and the value of

$$\frac{{d}_{r}}{{d}_{R}}$$

may be 0.05, 0.08, 0.10, 0.20, 0.30, 0.40, 0.50, etc.

0°≤θ≤110°, wherein if the value of θ is too large, it is unfavorable for stress relief, and the specific value may be 0°, 5°, 10°, 20°, 30°, 40°, 50°, 60°, 70°, 80°, 90°, 100°, 110°, etc.

0.1≤ε≤0.4, wherein if the value of ε is too large, it will cause capacity loss and is also unfavorable for structural stability, while if the value is too small, it is unfavorable for stress release. The value of ε may be 0.1, 0.2, 0.3, 0.4, etc.

3 μm≤Dvmax≤15 μm, 6 μm≤Dv90≤25 μm, and 2 μm≤Dv10≤8 μm. Values of Dv90, Dv10, and Dvmax within the above range are more favorable for stress release. Specifically, the value of Dvmax may be 3 μm, 5 μm, 8 μm, 10 μm, 13 μm, 15 μm, etc.; the value of Dv90 may be 6 μm, 10 μm, 15 μm, 20 μm, 25 μm, etc.; and the value of Dv10 may be 2 μm, 3 μm, 4 μm, 5 μm, 6 μm, 7 μm, 8 μm, etc.

4.4 g/cm³≤ρ≤5.1 g/cm³, and 3.15 g/cm³≤CD≤3.85 g/cm³. Values of ρ and CD within the above range enable a more appropriate value of ε, which is favorable for stress relief without compromising structural stability. Specifically, the value of ρ may be 4.4 g/cm³, 4.5 g/cm³, 4.6 g/cm³, 4.7 g/cm³, 4.8 g/cm³, 4.9 g/cm³, 5.0 g/cm³, 5.1 g/cm³, etc.; and the value of CD may be 3.15 g/cm³, 3.20 g/cm³, 3.30 g/cm³, 3.40 g/cm³, 3.50 g/cm³, 3.60 g/cm³, 3.70 g/cm³, 3.80 g/cm³, 3.85 g/cm³, etc.

The embodiments of the present disclosure further provide a preparation method of a ternary cathode material, which includes the following steps.

### S1: Preparation of a Precursor Intermediate

A co-precipitation reaction is carried out using a cobalt source, a nickel source, and a manganese source in the presence of a precipitant and a complexing agent to obtain a precursor intermediate in the form of a slurry. In the actual operation process, a mixed nickel-cobalt-manganese salt solution, a precipitant solution and a complexing agent solution are introduced into a reaction kettle containing a base solution, a resulting mixture is allowed to react for 2 h-3 h under stirring, such as 2.0 h, 2.5 h, 3.0 h, etc., and then the feeding of the three solutions is stopped.

In some embodiments, the mixed nickel-cobalt-manganese salt solution is obtained by mixing a nickel source, a cobalt source, a manganese source, and a solvent, and a molar ratio of nickel, cobalt, and manganese is 5:2:3, 1:1:1, 4:2:4, 6:2:2, 8:1:1 or 86-96:2-9:2-5. The molar ratio of nickel, cobalt and manganese may be any one of the above, for example 5:2:3, 1:1:1, 4:2:4, 6:2:2, 8:1:1, 86:9:5, 88:8:4, 90:7:3, 92:5:3, 96:2:2, etc. The type of solvent is not limited, which may be for example water. The cobalt source is at least one of cobalt sulfate or a hydrate thereof, the nickel source is at least one of nickel sulfate or a hydrate thereof, and the manganese source is at least one of manganese sulfate or a hydrate thereof. A concentration of the mixed nickel-cobalt-manganese salt solution is 1.5 mol/L to 2.2 mol/L, for example 1.5 mol/L, 1.8 mol/L, 2.0 mol/L, 2.2 mol/L, etc. A feed rate of the mixed nickel-cobalt-manganese salt solution is 25 mL/min to 35 mL/min, for example 25 mL/min, 28 mL/min, 30 mL/min, 32 mL/min, 35 mL/min, etc. By adjusting the concentration and feed rate of the mixed nickel-cobalt-manganese salt solution, a growth rate of solid particles may be suitably regulated, thereby improving the uniformity of the product.

In some embodiments, the precipitant solution may be a sodium hydroxide solution, and a concentration of the sodium hydroxide solution may be 10 mol/L to 12 mol/L, for example, 10 mol/L, 11 mol/L, 12 mol/L, etc. By adjusting a feed rate of the sodium hydroxide solution, a pH of the solution in the reaction kettle is maintained at 11.0 to 11.5, for example 11.0, 11.1, 11.2, 11.3, 11.4, 11.5, etc. The complexing agent solution may be an aqueous ammonia solution, and an ammonia concentration of the solution in the reaction kettle is kept at 0.7 mol/L to 1.1 mol/L, for example 0.7 mol/L, 0.8 mol/L, 0.9 mol/L, 1.0 mol/L, 1.1 mol/L, etc., by adjusting a feed rate of the aqueous ammonia solution. By adjusting the pH and ammonia concentration of the solution in the reaction kettle to satisfy the requirements of the co-precipitation reaction, a suitable precipitation rate may be regulated.

In some embodiments, during the process of preparing the precursor intermediate, a reaction temperature is controlled at 45° C. to 60° C., for example 45° C., 50° C., 55° C., 60° C., etc.; a stirring speed is 400 rpm to 700 rpm, for example 400 rpm, 500 rpm, 600 rpm, 700 rpm, etc.

It should be noted that the ammonia concentration, pH of the reaction, feed rate, and stirring speed have an impact on the porosity level of secondary particles, as well as the sizes of both the secondary and primary particles. Therefore, the particle size distribution and porosity level of the material as well as the size of primary particles may be regulated by adjusting the reaction parameters.

### S2: Preparation of a Precursor

After a pH of the precursor intermediate obtained in step S1 is adjusted to 8-9, the precursor intermediate is mixed and reacted with a directing agent, and then mixed and reacted with an initiator. Subsequently, the pH is raised and the co-precipitation reaction is continued using a cobalt source, a nickel source, and a manganese source. A solid-liquid separation is then performed to obtain the precursor. The addition of the directing agent and the initiator allows regulation of grain arrangement, enhances ordered arrangement, and renders the size of primary particles more controllable.

In some embodiments, the directing agent is at least one selected from the group consisting of allylphosphonic acid monoammonium salt, vinyl phosphoric acid (VPA), cis-propenyl phosphoric acid (cPPA), and allyl phosphoric acid (APA), and the directing agent may be any one or more of the above. The directing agent is controlled to be added at a concentration of 0.7 mol/L to 1.0 mol/L, for example 0.7 mol/L, 0.8 mol/L, 0.9 mol/L, 1.0 mol/L, etc. The reaction with the directing agent is carried out at a temperature of 15° C. to 35° C., for example 15° C., 20° C., 25° C., 30° C., and 35° C., etc., for a duration of 1.5 h to 2.5 h, for example 1.5 h, 1.8 h, 2.0 h, 2.3 h, 2.5 h, etc.

In some embodiments, the initiator is at least one selected from the group consisting of 2,2-azobis(2-methylpropylamidine) dihydrochloride and azodiisobutylamidine hydrochloride (V-50), and the initiator may be any one or more of the above. The initiator is controlled to be added at a concentration of 4 g/L to 6 g/L, for example 4.0 g/L, 4.5 g/L, 5.0 g/L, 5.5 g/L, 6.0 g/L, etc. The reaction with the initiator is carried out at a temperature of 15° C. to 35° C., for example 15° C., 20° C., 25° C., 30° C., 35° C., etc., for a duration of 1.5 h to 2.5 h, for example 1.5 h, 1.8 h, 2.0 h, 2.3 h, 2.5 h, etc.

It should be noted that during the precipitation process of the precursor, unsaturated transition metal atoms exposed on the (010) crystal plane of precursor particles may strongly coordinate with phosphate groups of the directing agent to form insoluble soaps that adsorb on the crystal plane. In addition, outward-facing double bonds in the directing agent will undergo a polymerization reaction, under the action of the initiator, with outward-facing double bonds in the directing agent on the (010) crystal plane of the free grains, guiding the grains to arrange in an orderly manner and reducing an angular deviation of primary particles from a radial direction of the minimum circumcircle of the secondary particles. The addition of the directing agent hinders the adsorption of metal-ammonia complex ions on the (010) crystal plane, thereby suppressing

growth along the crystal orientation and promoting growth of grains in the orientation. This process simultaneously enhances the ordered arrangement of grains.

In some embodiments, ultrasonic oscillation is applied during both the reactions with the directing agent and the initiator, and is applied at a frequency of 15 kHz to 30 kHz, for example 15 kHz, 20 kHz, 25 kHz, 30 kHz, etc. Ultrasonic oscillation is applied during both the reactions with the directing agent and the initiator, which on the one hand loosens the grains within the secondary particles, facilitating arrangement of the primary particles, and on the other hand increases the exposed area of the (010) crystal plane, thereby promoting the ordered arrangement of primary particles with controllable size.

In some embodiments, the pH of the precursor intermediate is adjusted using an acid solution to 8-9, for example 8.0, 8.3, 8.5, 8.7, 9.0, etc. The acid solution is at least one selected from the group consisting of sulfuric acid solution, acetic acid solution, and citric acid solution, and may be any one or more of the above.

In some embodiments, after the reaction with the initiator is completed, the pH is raised using a sodium hydroxide solution to 11.0-11.5, for example 11.0, 11.1, 11.2, 11.3, 11.4, 11.5, etc. A mixed nickel-cobalt-manganese salt solution, a precipitant solution and a complexing agent solution are then introduced to carry out the co-precipitation reaction for 6 h to 20 h, for example 6 h, 8 h, 10 h, 13 h, 15 h, 18 h, 20 h, etc. Afterwards, a resulting reaction solution is subjected to solid-liquid separation, washing, and drying to obtain the precursor. The method of solid-liquid separation is not limited and may be a filtration method, etc. The washing may be performed with water, and the number of water washing is not limited.

### S3: Calcination

The precursor is mixed with a lithium source and then calcined to obtain the ternary cathode material.

In order to enhance the electrochemical performance of the ternary cathode material, the calcination process is optimized as follows: the precursor is mixed with a lithium source and subjected to a two-step calcination to obtain a ternary cathode material intermediate; and afterwards, the ternary cathode material intermediate is mixed with a coating agent and then calcined.

In some embodiments, the two-step calcination includes: first, maintaining the temperature at 400° C.-550° C. for 3 h-5 h, and then raising the temperature to 750° C.-800° ° C. and maintaining the temperature for 12 h-15 h, a heating rate for the two-step calcination may be both 2° C./min to 4° C./min. Specifically, a first-step calcination may be carried out at a temperature of 400° C., 450° C., 500° C., 550° C., etc., and the temperature may be held for 3 h, 4 h, 5 h, etc. A second-step calcination may be carried out at a temperature of 750° C., 760° C., 770° C., 780° C., 790° C., 800° C., etc., and the temperature may be held for 12 h, 13 h, 14 h, 15 h, etc. The two-step calcination may be carried out in an atmosphere of air or oxygen.

Further, when feeding the materials, a molar ratio of lithium to a total amount of nickel, cobalt and manganese is controlled to be 1.03-1.07:1, for example 1.03:1, 1.04:1, 1.05:1, 1.06:1, 1.07:1, etc. The precursor and the lithium source that satisfy the specified ratio are mixed, ground, and then subjected to the two-step calcination to improve the uniformity of a cathode material product. The lithium source is at least one selected from the group consisting of lithium hydroxide, lithium carbonate, and lithium oxalate, and may be any one or more of the above.

In some embodiments, the coating agent is at least one selected from the group consisting of V₂O₅, Al₂O₃, ZrO₂, TiO₂, SnO₂, ZnO, MgO, RuO₂, La₂O₃, CeO₂, Co₃O₄, SiO₂, FePO₄, Li₃PO₄, Li₂MnO₃, LiAlO₂, Li₂TiO₃, Li₂ZrO₃, Li₃VO₄, Li₂SiO₃, AlF₃, LaF₃, and MgF₂, and may be any one or more of the above. Surface coating of the cathode material together with the introduction of the aforementioned dopants both contribute to enhanced cycling stability of the cathode material. A mass ratio of the coating agent to the ternary cathode material intermediate is 5-10:100, for example 5:100, 6:100, 7:100, 8:100, 9:100, 10:100, etc.

Further, the ternary cathode material intermediate and the coating agent are calcined at a temperature of 550° C. to 650° C., for example 550° C., 580° C., 600° C., 630° C., 650° C., etc., for a duration of 3 h-8 h, for example 3 h, 4 h, 5 h, 6 h, 7 h, 8 h, etc.

The embodiments of the present disclosure further provide a lithium-ion battery, including the ternary cathode material provided in the embodiments of the present disclosure. Since the ternary cathode material having an F value within the specified range has excellent structural stability, it contributes to improved cycling stability of the lithium-ion battery.

The features and performance of the present disclosure are further described in detail below in conjunction with the examples.

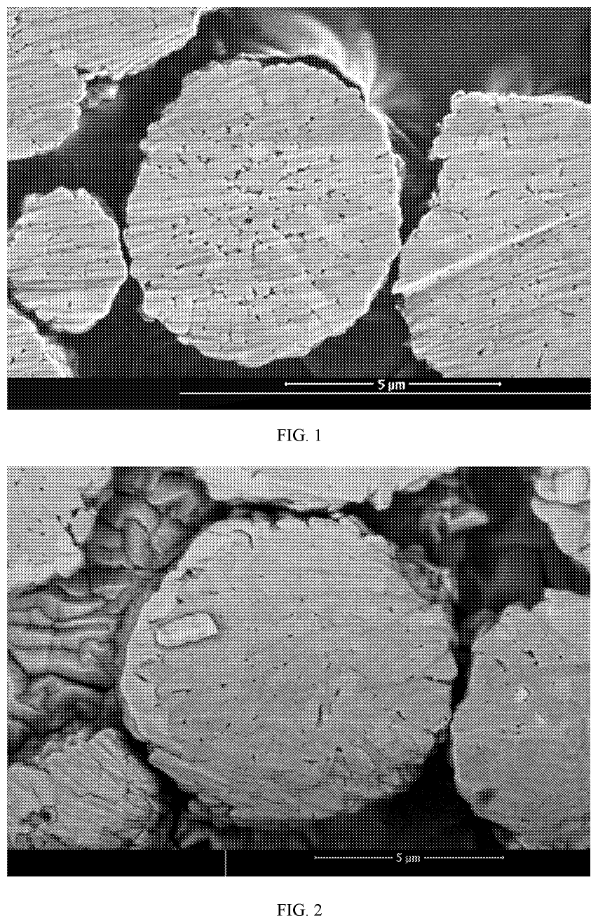

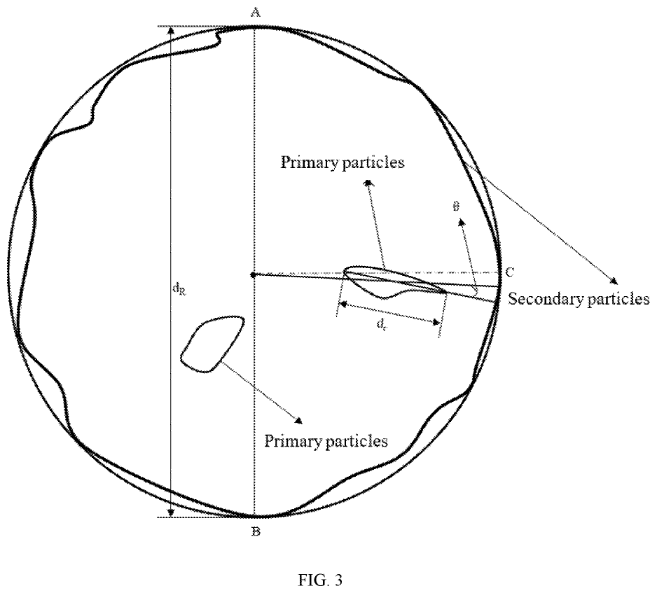

The examples of the present disclosure provided the ternary cathode materials as shown in Table 1. The ternary cathode materials of the Examples and Comparative Examples in Table 1 were tested, and the specific items and methods were as follows:
(1) Particle size distribution: According to GB/T 19077-2016, a laser particle size analyzer was used to test the particle size distribution of the ternary cathode materials provided in the Examples and Comparative Examples.
(2) Morphological characterization: A scanning electron microscope was used to test cross-sections of the ternary cathode materials provided in the Examples and Comparative Examples. FIG. 1 shows an SEM image of the cross-section of the ternary cathode material provided in Example 1, and FIG. 2 shows an SEM image of the cross-section of the ternary cathode material provided in Comparative Example 1. The primary particles in FIG. 1 are arranged in a relatively orderly manner.
(3) Method for testing an angular deviation of primary particles from a radial direction of the minimum circumcircle of secondary particles (referring to FIG. 3 for specific process): 1) an analyzable SEM image of the cross-section of the ternary cathode material was obtained; 2) a maximum Feret diameter of the secondary particle cross-section was determined using tools in ImageJ, and a point C on a secondary particle cross-section with the maximum perpendicular distance to the Feret diameter was identified, two ends of the Feret's diameter were denoted as points A and B, respectively, a circle passing through points A, B, and C was constructed to obtain a minimum circumcircle of the corresponding secondary particle cross-section of the ternary cathode material, and the center of the corresponding minimum circumcircle was determined; 3) boundaries of the primary particles in the SEM image were identified using tools in ImageJ, and each region of the primary particles in the SEM image was independently selected; and 4) the maximum Feret diameter of each region of primary particles and the minimum circumcircle diameter of secondary particles were obtained by analyzing with ImageJ, and an angle θ between a radius at a direction of the minimum circumcircle of the secondary particle cross-section passing through the midpoint of the maximum Feret diameter of the primary particle cross-section in the secondary particle cross-section, and the maximum Feret diameter of the primary particle cross-section oriented toward the direction with a shorter distance to the minimum circumcircle was also obtained.
(4) Compaction density test: According to GB/T 24533-2009, a compaction density tester was used to test the ternary cathode materials provided in the Examples and Comparative Examples. The test results of the Examples and Comparative Examples were shown in Table 1.
(5) True density test: According to GB/T 24586-2009, a BeiShiDe Physical Adsorption Analyzer-TD was used to test the ternary cathode materials provided in the Examples and Comparative Examples. The test results of the Examples and Comparative Examples were shown in Table 1.
(6) Electrochemical performance test:

Battery fabrication method: a prepared cathode material, acetylene black, and PVDF were weighed in a mass ratio of 90:5:5, added to N-methyl-2-pyrrolidone (NMP), and thoroughly mixed under stirring, followed by ultrasonic dispersion to obtain a slurry. The slurry was evenly coated on an aluminum foil, which was then transferred to a vacuum oven and dried at 120° C. for 12 h. After drying, a dry electrode sheet was taken out, calendered, and punched to obtain a circular cathode sheet with a diameter of 14 mm. Using a lithium metal sheet as an anode, a 1 mol·L⁻¹ of LiPF₆ organic solution (EC:DEC:DMC=1:1:1, by volume ratio) as an electrolyte, and a Celgrd2400 polypropylene microporous membrane as a separator, a button battery was assembled in a glove box under the protection of high-purity argon. After assembly, the battery was allowed to stand for 4 h, and then the electrochemical performance test was performed on a LAND battery testing system.

Electrochemical performance test: the button batteries were fabricated using the cathode materials provided in the Example and Comparative Examples, respectively. The specific discharge capacities at 0.1 C, 1 C, 2 C, and 5 C were tested at 25° C. The capacity retention rates after 100 and 300 cycles were evaluated at room temperature. The cycling performance test was carried out on a LAND charge/discharge tester within voltage ranges of 3.0-4.3 V (622\523) and 2.8-4.30 V (811). The results were shown in Table 2.

It should be noted that 50 primary particles were selected, and the selection of the 50 primary particles should satisfy the following conditions:

$$\frac{{d}_{r}}{{d}_{R}} < 0.1 and 0.1 \leq \frac{{d}_{r}}{{d}_{R}} ,$$

and the number of primary particles with

$$\frac{{d}_{r}}{{d}_{R}} < 0.1$$

selected is 2.5-3.5 times the number of primary particles with

$$0.1 \leq \frac{{d}_{r}}{{d}_{R}}$$

selected.

An average value of the parameters was also calculated from the 50 particles.

TABLE 1
Parameters of Ternary Cathode Materials Provided in Examples and Comparative Examples

| Items | (dᵣ/d_{R}) Average value | Average value of θ (°) | $\frac{{\sum }_{1}^{n} ( \frac{{d}_{r}}{{d}_{R}} \times θ )}{n} ( ° )$ | $\frac{Dv 90 - Dv max}{Dv max - Dv 10}$ | ρ, g/cm³ | CD, g/cm³ | ε | [1000 × (ε - 0.25)² + 0.1] | F (°) |
|---|---|---|---|---|---|---|---|---|---|
| Example 1 | 0.15 | 48.40 | 5.67 | 3.50 | 4.73 | 3.41 | 0.28 | 0.95 | 18.85 |
| Example 2 | 0.17 | 67.80 | 6.80 | 3.60 | 4.61 | 3.31 | 0.28 | 1.12 | 27.42 |
| Example 3 | 0.13 | 37.58 | 4.56 | 3.25 | 4.68 | 3.39 | 0.28 | 0.76 | 11.26 |
| Example 4 | 0.27 | 52.60 | 7.25 | 3.62 | 4.76 | 3.44 | 0.28 | 0.85 | 22.31 |
| Example 5 | 0.09 | 42.50 | 2.82 | 3.61 | 4.62 | 3.59 | 0.22 | 0.83 | 8.45 |
| Example 6 | 0.24 | 45.40 | 6.68 | 3.51 | 4.76 | 3.54 | 0.26 | 0.14 | 3.28 |
| Example 7 | 0.16 | 53.15 | 6.24 | 3.36 | 4.50 | 3.20 | 0.29 | 1.61 | 33.76 |
| Example 8 | 0.15 | 49.50 | 5.86 | 3.54 | 4.75 | 3.58 | 0.25 | 0.11 | 2.28 |
| Example 9 | 0.15 | 49.00 | 5.74 | 6.24 | 4.64 | 3.54 | 0.24 | 0.27 | 9.67 |
| Example 10 | 0.15 | 46.34 | 5.42 | 0.85 | 4.79 | 3.62 | 0.24 | 0.13 | 0.60 |
| Example 11 | 0.12 | 22.40 | 6.64 | 3.78 | 4.67 | 3.66 | 0.22 | 1.24 | 31.12 |
| Example 12 | 0.15 | 48.00 | 5.57 | 3.46 | 4.72 | 3.68 | 0.22 | 0.98 | 18.89 |
| Comparative | 0.17 | 62.71 | 7.34 | 3.62 | 4.55 | 3.16 | 0.31 | 3.18 | 84.50 |
| Example 1 | | | | | | | | | |
| Comparative | 0.20 | 76.10 | 9.25 | 3.57 | 4.66 | 3.26 | 0.30 | 2.64 | 87.18 |
| Example 2 | | | | | | | | | |
| Comparative | 0.22 | 80.73 | 10.12 | 4.21 | 4.67 | 3.29 | 0.30 | 2.17 | 92.45 |
| Example 3 | | | | | | | | | |
| Comparative | 0.21 | 71.70 | 8.75 | 3.85 | 4.58 | 3.21 | 0.30 | 2.51 | 84.56 |
| Example 4 | | | | | | | | | |
| Comparative | 0.70 | 5.85 | 0.54 | 1.45 | 4.45 | 3.32 | 0.25 | 0.12 | 0.09 |
| Example 5 | | | | | | | | | |
| Comparative | 0.22 | 60.85 | 7.15 | 3.79 | 4.51 | 3.12 | 0.31 | 3.49 | 94.57 |
| Example 6 | | | | | | | | | |

TABLE 2
Electrochemical Performances of Ternary Cathode Materials
Provided in Examples and Comparative Examples

| | | | | | Capacity | Capacity |
|---|---|---|---|---|---|---|
| | Specific | Specific | Specific | Specific | retention | retention |
| | discharge | discharge | discharge | discharge | rate after | rate after |
| | capacity at | capacity at | capacity at | capacity at | 100 cycles | 300 cycles |
| Indexes | 0.1 C, mAh/g | 1 C, mAh/g | 2 C, mAh/g | 5 C, mAh/g | at 1 C, % | at 1 C, % |
| Example 1 | 203.700 | 183.737 | 176.812 | 168.664 | 89.36 | 74.11 |
| Example 2 | 202.460 | 182.012 | 174.723 | 167.030 | 89.14 | 73.98 |
| Example 3 | 203.740 | 184.385 | 177.254 | 169.104 | 89.41 | 74.12 |
| Example 4 | 201.380 | 181.242 | 174.194 | 166.541 | 89.12 | 74.00 |
| Example 5 | 203.620 | 187.330 | 177.964 | 171.041 | 89.96 | 75.49 |
| Example 6 | 199.990 | 184.191 | 174.991 | 168.792 | 90.04 | 75.70 |
| Example 7 | 200.460 | 179.211 | 172.396 | 164.778 | 89.09 | 73.86 |
| Example 8 | 201.580 | 185.857 | 176.383 | 170.537 | 91.76 | 77.86 |
| Example 9 | 199.460 | 183.304 | 173.530 | 166.549 | 89.74 | 74.34 |
| Example 10 | 202.650 | 187.249 | 177.521 | 172.050 | 92.46 | 77.92 |
| Example 11 | 183.500 | 168.820 | 155.975 | 144.965 | 98.59 | 92.12 |
| Example 12 | 170.200 | 156.584 | 149.776 | 136.160 | 99.46 | 93.25 |
| Comparative | 198.250 | 173.865 | 169.702 | 162.169 | 85.46 | 71.28 |
| Example 1 | | | | | | |
| Comparative | 199.440 | 173.114 | 169.325 | 162.145 | 84.18 | 70.14 |
| Example 2 | | | | | | |
| Comparative | 200.140 | 170.119 | 168.118 | 162.113 | 85.30 | 71.00 |
| Example 3 | | | | | | |
| Comparative | 198.620 | 172.799 | 169.224 | 161.875 | 82.45 | 68.58 |
| Example 4 | | | | | | |
| Comparative | 196.450 | 178.770 | 167.375 | 163.054 | 83.36 | 68.45 |
| Example 5 | | | | | | |
| Comparative | 198.650 | 167.859 | 165.873 | 159.913 | 84.02 | 70.08 |
| Example 6 | | | | | | |

Different

$$\frac{{\sum }_{1}^{n} ( \frac{{d}_{r}}{{d}_{R}} \times θ )}{n}$$

values are obtained by varying the ratio of primary particle size to corresponding secondary particle size and the deviation angle of the primary particle. Different porosities (ε) are obtained by varying the true density (ρ) and compaction density (CD). Further, different F values are obtained by varying the

$$\frac{{\sum }_{1}^{n} ( \frac{{d}_{r}}{{d}_{R}} \times θ )}{n} ,$$

the particle size distribution

$$\frac{Dv 90 - Dvmax}{Dvmax - Dv 10}$$

of large and small particles, and the porosity. The ternary cathode materials with F in the range of 0.5°≤F≤40° exhibit superior rate performance and cycling performance.

The relative size of the primary particles with respect to the corresponding secondary particles, together with the angular deviation of the primary particles from the radius of the minimum circumcircle of the secondary particles reflects the degree of arrangement order of primary particles during the formation of secondary particles. The value of

$$\frac{{\sum }_{1}^{n} ( \frac{{d}_{r}}{{d}_{R}} \times θ )}{n}$$

reflects the superiority or inferiority of the arrangement order. Specifically, the smaller the ratio of

$$\frac{{d}_{r}}{{d}_{R}} ,$$

the smaller the impact of θ on the overall arrangement order of secondary particles, and the smaller the θ value, the better the arrangement order. Therefore, the relationship between the primary particles and corresponding secondary particles in ternary cathode materials is represented by the formula

$$\frac{{d}_{r}}{{d}_{R}} \times θ ,$$

wherein a smaller value corresponds to a higher degree of arrangement order.

True density (ρ) and compaction density (CD) together determine different porosities (ε), reflecting an overall porosity of the cathode material. If the porosity is too low, it hinders the stress release associated with particle contraction and expansion during charge-discharge cycling. Conversely, if the porosity is too high, it leads to a low bulk density. Compared with Example 1, the ternary cathode materials provided in Examples 7-8 have different porosities, corresponding to different F values, resulting in different rate performance and cycling performance.

The proportions of particles with different diameters on either side of the peak corresponding to the maximum volume fraction in the particle size distribution reflect the proportions of large and small particles in the cathode material, affecting the value

$$\frac{Dv 90 - Dvmax}{Dvmax - Dv 10} .$$

The larger the value, the higher the proportion of large particles and the lower the cycling performance of the cathode material; while the smaller the value, the higher the proportion of small particles and the relatively better the cycling performance of the cathode material. Compared with Example 1, Examples 9-10 correspond to different

$$\frac{Dv 90 - Dvmax}{Dvmax - Dv 10}$$

and different F values, and correspond to different rate performance and cycling performance of the cathode materials.

The preparation methods of the above Examples and Comparative Examples were described below.

### Example 1

### (1) Preparation of a Precursor Intermediate:

Nickel sulfate, cobalt sulfate, and manganese sulfate were mixed in a molar ratio of 8:1:1 and dissolved in water to obtain a metal salt solution, which was added to a base solution at a certain rate, and then a NaOH solution with a concentration of 10 mol/L was added at a certain rate to maintain the pH of the solution in the reaction kettle at 11.3, while nitrogen was introduced and an NH₃·H₂O solution with a concentration of 2 mol/L was added at a certain rate to obtain a mixture, the mixture was allowed to react for 2.5 h under stirring to obtain the precursor intermediate, after which feeding was stopped. A concentration of the metal salt solution was 2 mol/L, and a feed rate was 30 mL/min. The reaction was carried out at a temperature of 55° C. and a stirring speed of 500 rpm. Wherein a concentration of NH₃·H₂O solution in the reaction kettle was 0.9 mol/L. The base solution was obtained by mixing a sodium hydroxide solution, an NH₃·H₂O solution, and water, and had a pH of 11.3. An ammonia concentration of the base solution was 0.1 mol/L (i.e., the concentration of NH₃).

### (2) Preparation of a Precursor:

After adding sulfuric acid solution to the reaction kettle to adjust the pH of the solution in the reaction kettle to 8.5, ultrasonic oscillation was applied and allylphosphonic acid monoammonium salt was added. The temperature was lowered to 25° C. and the reaction was carried out for 2 h, then 2,2-azobis(2-methylpropylamidine) dihydrochloride was added and the reaction was continued at 25° C. for 2 h. The temperature was raised to the original reaction temperature of step (1), then a NaOH solution was added and the pH of the solution in the reaction kettle was maintained at 11.3, then a metal salt solution and an NH₃·H₂O solution were added continuously and the reaction was continued for 15 h. A resulting reaction solution was then subjected to filtration, washing, and drying to obtain the precursor. Wherein a concentration of allylphosphonic acid monoammonium salt in the solution in the reaction kettle was 0.85 mol/L; a concentration of 2,2-azobis(2-methylpropylamidine) dihydrochloride in the solution in the reaction kettle was 5 g/L; and the ultrasonic oscillation was applied at a frequency of 25 kHz.

### (3) Preparation of a Ternary Cathode Material:

After the precursor and lithium carbonate were mixed in a molar ratio of Li:(Ni+Co+Mn) of 1.05:1, a resulting mixture was ground and subjected to a two-step calcination. The calcination was performed in an oxygen atmosphere, and the two-step calcination included a first-step calcination, including raising a temperature to 480° C. and maintaining the temperature for 4 h, then continuously raising the temperature to 750° C. and maintaining the temperature for 15 h to obtain the ternary cathode material intermediate, wherein a heating rate was 3° C./min.

After TiO₂ as a coating agent and the ternary cathode material intermediate were mixed in a mass ratio of 6:100, a resulting mixture was calcined at 600° C. for 6 h to obtain the ternary cathode material.

The preparation method settings of Examples and Comparative Examples (conditions not listed in the table below are the same as those corresponding to Example 1):

### (1) Preparation of a Precursor Intermediate:

TABLE 3
Parameter Settings for Preparation of Precursor Intermediates in Examples and Comparative Examples

| | Molar ratio | | | | | | | |
|---|---|---|---|---|---|---|---|---|
| | of nickel, | Concentration | Feed | Concentration | | Reaction | Reaction | Stirring |
| | cobalt and | of metal salt | rate | of NH₃•H₂O | | time | temperature | speed |
| Categories | manganese | (mol/L) | (mL/min) | (mol/L) | pH | (h) | (°C) | (rpm) |
| Example 1 | 8:1:1 | 2 | 30 | 0.9 | 11.3 | 2.5 | 55 | 500 |
| Example 2 | 8:1:1 | 2.1 | 31 | 0.8 | 11.3 | 3 | 55 | 550 |
| Example 3 | 8:1:1 | 1.8 | 28 | 1 | 11.2 | 3 | 55 | 480 |
| Example 4 | 8:1:1 | 1.5 | 25 | 1.1 | 11 | 3 | 55 | 600 |
| Example 5 | 8:1:1 | 2.2 | 30 | 0.8 | 11.4 | 2 | 50 | 400 |
| Example 6 | 8:1:1 | 1.6 | 27 | 1.1 | 11.1 | 3 | 55 | 600 |
| Example 7 | 8:1:1 | 2.1 | 35 | 1.1 | 11.5 | 3 | 55 | 700 |
| Example 8 | 8:1:1 | 1.7 | 25 | 0.86 | 11 | 2.5 | 55 | 600 |
| Example 9 | 8:1:1 | 1.8 | 30 | 0.7 | 11 | 3 | 55 | 400 |
| Example 10 | 8:1:1 | 2.2 | 35 | 1.1 | 11.5 | 3 | 55 | 700 |
| Example 11 | 6:2:2 | 1.95 | 28 | 0.95 | 11.3 | 2.5 | 55 | 500 |
| Example 12 | 5:2:3 | 1.9 | 27 | 1 | 11.3 | 2.5 | 55 | 500 |
| Comparative | 8:1:1 | 1.4 | 30 | 1.2 | 11.3 | 2.5 | 45 | 400 |
| Example 1 | | | | | | | | |
| Comparative | 8:1:1 | 1.4 | 30 | 1.1 | 11.2 | 2.5 | 60 | 450 |
| Example 2 | | | | | | | | |
| Comparative | 8:1:1 | 1.4 | 30 | 1.1 | 11.4 | 2.5 | 55 | 450 |
| Example 3 | | | | | | | | |
| Comparative | 8:1:1 | 1.4 | 30 | 1.1 | 11.3 | 2.5 | 55 | 440 |
| Example 4 | | | | | | | | |
| Comparative | 8:1:1 | 1.5 | 25 | 0.7 | 11.6 | 2 | 60 | 900 |
| Example 5 | | | | | | | | |
| Comparative | 8:1:1 | 2 | 30 | 0.9 | 11.3 | 2.5 | 55 | 500 |
| Example 6 | | | | | | | | |

### (2) Preparation of a Precursor:

TABLE 4
Parameter Settings for Preparation of Precursors in Examples and Comparative Examples

| | Preparation process of precursors | | | | | | | |
|---|---|---|---|---|---|---|---|---|
| | pH | Frequency | | Concentration | Reaction time | | | Reaction |
| | adjusted | of ultrasonic | | of directing | of directing | | Concentration | time of |
| | by | oscillation | Directing | agent | agent | | of initiator | initiator |
| Categories | acid | (kHz) | agent | (mol/L) | (h) | Initiator | (g/L) | (h) |
| Example 1 | 8.5 | 25 | Allylphosphonic | 0.85 | 2 | 2,2-azobis(2- | 5 | 2 |
| | | | acid | | | methylpropyl- | | |
| | | | monoammonium | | | amidine)dihydrochloride | | |
| | | | salt | | | | | |
| Example 2 | 8.5 | 15 | VPA | 0.75 | 1.5 | 2,2-azobis(2- | 4 | 1.5 |
| | | | | | | methylpropyl- | | |
| | | | | | | amidine)dihydrochloride | | |
| Example 3 | 8.5 | 30 | VPA | 1 | 2.5 | V-50 | 5.5 | 2.5 |
| Example 4 | 8.5 | 22 | VPA | 0.82 | 2.5 | V-50 | 4.8 | 2.5 |
| Example 5 | 8.5 | 28 | VPA | 0.9 | 2.5 | V-50 | 5.6 | 2.5 |
| Example 6 | 8.5 | 30 | VPA | 0.95 | 2 | V-50 | 5.3 | 2.3 |
| Example 7 | 9 | 15 | APA | 0.7 | 2 | V-50 | 5 | 2 |
| Example 8 | 8 | 30 | Allylphosphonic | 1 | 2.5 | V-50 | 6 | 2.5 |
| | | | acid | | | | | |
| | | | monoammonium | | | | | |
| | | | salt | | | | | |
| Example 9 | 8.5 | 25 | Allylphosphonic | 0.85 | 2 | 2,2-azobis(2- | 5 | 2 |
| | | | acid | | | methylpropyl- | | |
| | | | monoammonium | | | amidine)dihydrochloride | | |
| | | | salt | | | | | |
| Example 10 | 8.5 | 25 | Allylphosphonic | 0.85 | 2 | 2,2-azobis(2- | 5 | 2 |
| | | | acid | | | methylpropyl- | | |
| | | | monoammonium | | | amidine)dihydrochloride | | |
| | | | salt | | | | | |
| Example 11 | 8.5 | 25 | Allylphosphonic | 0.85 | 2 | 2,2-azobis(2- | 5 | 2 |
| | | | acid | | | methylpropyl- | | |
| | | | monoammonium | | | amidine)dihydrochloride | | |
| | | | salt | | | | | |
| Example 12 | 8.5 | 25 | Allylphosphonic | 0.85 | 2 | 2,2-azobis(2- | 5 | 2 |
| | | | acid | | | methylpropyl- | | |
| | | | monoammonium | | | amidine)dihydrochloride | | |
| | | | salt | | | | | |
| Comparative | None | 25 | None | None | None | 2,2-azobis(2- | 5 | 2 |
| Example 1 | | | | | | methylpropyl- | | |
| | | | | | | amidine)dihydrochloride | | |
| Comparative | None | 25 | Allylphosphonic | 0.85 | 2 | None | None | None |
| Example 2 | | | acid | | | | | |
| | | | monoammonium | | | | | |
| | | | salt | | | | | |
| Comparative | 8.5 | None | Allylphosphonic | 0.85 | 2 | 2,2-azobis(2- | 5 | 2 |
| Example 3 | | | acid | | | methylpropyl- | | |
| | | | monoammonium | | | amidine)dihydrochloride | | |
| | | | salt | | | | | |
| Comparative | 8.5 | Stop | Allylphosphonic | 0.85 | 2 | 2,2-azobis(2- | 5 | 2 |
| Example 4 | | stirring | acid | | | methylpropyl- | | |
| | | | monoammonium | | | amidine)dihydrochloride | | |
| | | | salt | | | | | |
| Comparative | 8.5 | 30 | None | None | None | None | None | None |
| Example 5 | | | | | | | | |
| Comparative | 8.5 | 25 | Styryl | 0.85 | 2 | 2,2-azobis(2- | 5 | 2 |
| Example 6 | | | phosphonate | | | methylpropyl- | | |
| | | | | | | amidine)dihydrochloride | | |

### (3) Preparation of a Ternary Cathode Material:

TABLE 5
Parameter Settings for Preparation of Ternary Cathode
Materials in Examples and Comparative Examples

| | Preparation of a cathode material | | | | | |
|---|---|---|---|---|---|---|
| | | First-step | Second-step | Second-step | | Amount of |
| | | maintaining | calcination | maintaining | Coating | coating |
| Categories | lithium source | time (h) | temperature (°C) | time (h) | agent | agent |
| Example 1 | Lithium carbonate | 4 | 750 | 15 | TiO₂ | 6 |
| Example 2 | Lithium hydroxide | 4 | 800 | 15 | TiO₂ | 6 |
| Example 3 | Lithium hydroxide | 4.5 | 800 | 14 | TiO₂ | 6 |
| Example 4 | Lithium hydroxide | 4.5 | 760 | 14 | TiO₂ | 6 |
| Example 5 | Lithium hydroxide | 4.5 | 780 | 14 | TiO₂ | 6 |
| Example 6 | Lithium hydroxide | 4.5 | 800 | 14 | TiO₂ | 6 |
| Example 7 | Lithium hydroxide | 4 | 750 | 15 | TiO₂ | 6 |
| Example 8 | Lithium hydroxide | 4 | 750 | 15 | TiO₂ | 6 |
| Example 9 | Lithium hydroxide | 4 | 750 | 15 | TiO₂ | 6 |
| Example 10 | Lithium hydroxide | 4 | 750 | 15 | TiO₂ | 6 |
| Example 11 | Lithium carbonate | 4 | 750 | 15 | Al₂O₃ | 8 |
| Example 12 | Lithium carbonate | 4 | 750 | 15 | ZnO | 9 |
| Comparative | Lithium hydroxide | 4 | 750 | 15 | TiO₂ | 6 |
| Example 1 | | | | | | |
| Comparative | Lithium hydroxide | 6 | 750 | 15 | TiO₂ | 6 |
| Example 2 | | | | | | |
| Comparative | Lithium hydroxide | 4 | 750 | 15 | TiO₂ | 6 |
| Example 3 | | | | | | |
| Comparative | Lithium hydroxide | 4 | 750 | 15 | TiO₂ | 6 |
| Example 4 | | | | | | |
| Comparative | Lithium hydroxide | 6 | 750 | 15 | TiO₂ | 6 |
| Example 5 | | | | | | |
| Comparative | Lithium hydroxide | 4 | 750 | 15 | TiO₂ | 6 |
| Example 6 | | | | | | |

It can be seen that by introducing a directing agent and an initiator to the reaction and combining with ultrasonic treatment, the value of F can be controlled within the range defined in the present disclosure, which is beneficial for improving the electrochemical performance of the material. This may be because the above methods affect the ordering of grains, which can increase the ordered arrangement and make the size of primary particles more controllable.

As shown in Tables 1-5, for materials with the same molar ratio of nickel, cobalt and manganese (as in Examples 1-10), their cycling performance gradually decreases as the F value increases within the specified range.

The above examples are only the preferred examples of the present disclosure, and are not intended to limit the present disclosure. For those skilled in the art, various modifications and changes may be made to the present disclosure. Any modifications, equivalent substitutions, and improvements, etc., made within the spirit and principles of the present disclosure should be included within the scope of protection of the present disclosure.

What is claimed is:

1. A ternary cathode material, satisfying:
$$F = \frac{{\sum }_{1}^{n} ( \frac{{d}_{r}}{{d}_{R}} \times θ )}{n} \times ( \frac{Dv 90 - Dvmax}{Dvmax - Dv 10} ) \times [ 1000 \times {( ε - 0.25 )}^{2} + 0 \text{.1} ] ;$$
$$0.5 ° \leq F \leq 40 ° ;$$
wherein F denotes a structural stability parameter of the ternary cathode material, in a unit of °,
dᵣ denotes a maximum Feret diameter of a primary particle cross-section of a primary particle within a secondary particle cross-section of the ternary cathode material, in a unit of μm;
dᵣ denotes a diameter of a minimum circumcircle of the secondary particle cross-section that contains the corresponding primary particle, in a unit of μm;
θ denotes an angle between a radius at a direction of the minimum circumcircle of the secondary particle cross-section passing through a midpoint of the maximum Feret diameter of the primary particle cross-section in the secondary particle cross-section and the maximum Feret diameter of the primary particle cross-section oriented toward a direction with a shorter distance to the minimum circumcircle, in a unit of °;
ε denotes a porosity, and
$$ε = \frac{ρ - C D}{ρ} ,$$
where ρ denotes a true density, CD denotes a compaction density, and both ρ and CD are in g/cm³;
Dv90 and Dv10 respectively denote particle sizes at which a cumulative volume of the ternary cathode material particles in a corresponding batch reaches 90% and 10%, Dvmax is a particle size corresponding to the maximum y value on a corresponding particle size distribution curve, and Dv90, Dv10, Dvmax are all in μm;
n denotes a number of primary particles selected from the same or different secondary particles, and n≥40.

2. The ternary cathode material of claim 1, wherein the ternary cathode material satisfies at least one of the following features A1 to K1:
$$Feature A 1 : 0.1 \leq \overline{( \frac{{d}_{r}}{{d}_{R}} )} \leq 1. ;$$
Feature B1: 0°≤θ̅≤70°;
$$Feature C 1 : 0.5 ° \leq \frac{{\sum }_{1}^{n} ( \frac{{d}_{r}}{{d}_{R}} \times θ )}{n} \leq 20 ° ;$$
$$Feature D 1 : 0 \text{.5} \leq \frac{Dv 90 - Dvmax}{Dvmax - Dv 10} \leq 20 ;$$
Feature E1: 0.1≤[1000×(ε−0.25)²+0.1]≤6.5;
$$Feature F 1 : {d}_{r} \leq 5 μm , 2 μm \leq {d}_{R} \leq 25 μm , 0.05 \leq \frac{{d}_{r}}{{d}_{R}} \leq 0.5 ;$$
Feature G1: 0°≤θ≤110°;
Feature H1: 0.1≤ε≤0.4;
Feature I1: 3 μm≤Dvmax≤15 μm, 6 μm≤Dv90≤25 μm, 2 μm≤Dv10≤8 μm;
Feature J1: 4.4 g/cm³≤ρ≤5.1 g/cm³, and 3.15 g/cm³≤CD≤3.85 g/cm³;
Feature K1: a selection of n primary particles satisfies the following conditions:
$$\frac{{d}_{r}}{{d}_{R}} < 0.1 and 0.1 \leq \frac{{d}_{r}}{{d}_{R}} ,$$
and a number of primary particles with
$$\frac{{d}_{r}}{{d}_{R}} < 0.1$$
selected is 2.2-3.3 times a number of primary particles with
$$0.1 \leq \frac{{d}_{r}}{{d}_{R}}$$
selected.

3. A preparation method of the ternary cathode material of claim 1, comprising:
subjecting a cobalt source, a nickel source, and a manganese source to a co-precipitation reaction to obtain a precursor intermediate;
adjusting a pH of the precursor intermediate to 8-9, followed by mixing and reaction with a directing agent, and then with an initiator, thereafter raising the pH and allowing a cobalt source, a nickel source, and a manganese source to continue the co-precipitation reaction, and then performing solid-liquid separation to obtain a precursor; and
mixing the precursor with a lithium source and then calcining.

4. The preparation method of claim 3, wherein a process of preparing the precursor using the precursor intermediate satisfies at least one of the following features A2 to E2:
Feature A2: the directing agent is at least one selected from the group consisting of allylphosphonic acid monoammonium salt, vinyl phosphoric acid, cis-propenyl phosphoric acid, and allyl phosphoric acid;
Feature B2: the directing agent is controlled to be added at a concentration of 0.7 mol/L to 1.0 mol/L;
Feature C2: the reaction with the directing agent is carried out at a temperature of 15° C. to 35° C. for 1.5 h to 2.5 h;
Feature D2: during the reactions with the directing agent and the initiator, ultrasonic oscillation is applied at a frequency of 15 kHz to 30 kHz;
Feature E2: an acid solution is used to adjust the pH of the precursor intermediate to 8-9, and the acid solution is at least one selected from the group consisting of sulfuric acid solution, acetic acid solution, and citric acid solution.

5. The preparation method of claim 3, wherein the process of preparing the precursor using the precursor intermediate satisfies at least one of the following features A3 to D3:
Feature A3: the initiator is at least one selected from the group consisting of 2,2-azobis(2-methylpropylamidine) dihydrochloride and azodiisobutylamidine hydrochloride;
Feature B3: the initiator is controlled to be added at a concentration of 4 g/L to 6 g/L;
Feature C3: the reaction with the initiator is carried out at a temperature of 15° C. to 35° C. for 1.5 h to 2.5 h;
Feature D3: after the reaction with the initiator is completed, the pH is raised to 11.0-11.5, and a mixed nickel-cobalt-manganese salt solution, a precipitant solution and a complexing agent solution are introduced for the co-precipitation reaction for 6 h-20 h, and then a resulting reaction solution is subjected to solid-liquid separation, washing, and drying to obtain the precursor.

6. The preparation method of claim 3, wherein a process of preparing the precursor intermediate comprises: introducing a mixed nickel-cobalt-manganese salt solution, a precipitant solution and a complexing agent solution into a reaction kettle containing a base solution to allow reaction under stirring for 2 h-3 h; wherein the mixed nickel-cobalt-manganese salt solution is obtained by mixing a nickel source, a cobalt source, and a manganese source, and a molar ratio of nickel, cobalt, and manganese is 5:2:3, 1:1:1, 4:2:4, 6:2:2, 8:1:1 or 86-96:2-9:2-5;
and/or, during the process of preparing the precursor intermediate, a reaction temperature is controlled at 45° C. to 60° C., and a stirring speed is controlled to be 400 rpm to 700 rpm.

7. The preparation method of claim 6, wherein the process of preparing the precursor intermediate satisfies at least one of the following features A4 to C4:
Feature A4: a concentration of the mixed nickel-cobalt-manganese salt solution is 1.5 mol/L to 2.2 mol/L, and a feed rate of the mixed nickel-cobalt-manganese salt solution is 25 mL/min to 35 mL/min;
Feature B4: the precipitant solution is a sodium hydroxide solution with a concentration of 10 mol/L to 12 mol/L, and a pH of the solution in the reaction kettle is maintained at 11.0 to 11.5 by adjusting a feed rate of the sodium hydroxide solution;
Feature C4: the complexing agent solution is an aqueous ammonia solution, and an ammonia concentration of the solution in the reaction kettle is kept at 0.7 mol/L to 1.1 mol/L by adjusting a feed rate of the aqueous ammonia solution.

8. The preparation method of claim 3, wherein the precursor is mixed with the lithium source and then subjected to a two-step calcination to obtain a ternary cathode material intermediate; and
the ternary cathode material intermediate is mixed with a coating agent and then calcined.

9. The preparation method of claim 8, wherein a process of preparing the ternary cathode material using a precursor satisfies at least one of the following features A5 to G5:
Feature A5: the two-step calcination comprises: first maintaining a temperature at 400° C. to 550° C. for 3 h-5 h, and then raising the temperature to 750° C. to 800° C. and maintaining the temperature for 12 h-15 h;
Feature B5: a molar ratio of lithium to a total amount of nickel, cobalt and manganese is controlled to be 1.03-1.07:1;
Feature C5: the precursor and the lithium source are mixed, ground and then subjected to the two-step calcination;
Feature D5: the lithium source is at least one selected from the group consisting of lithium hydroxide, lithium carbonate, and lithium oxalate;
Feature E5: the coating agent is at least one selected from the group consisting of V₂O₅, Al₂O₃, ZrO₂, TiO₂, SnO₂, ZnO, MgO, RuO₂, La₂O₃, CeO₂, Co₃O₄, SiO₂, FePO₄, Li₃PO₄, Li₂MnO₃, LiAlO₂, Li₂TiO₃, Li₂ZrO₃, Li₃VO₄, Li₂SiO₃, AlF₃, LaF₃, and MgF₂;
Feature F5: a mass ratio of the coating agent to the ternary cathode material intermediate is 5-10:100;
Feature G5: the calcination of the ternary cathode material intermediate and the coating agent is carried out at a temperature of 550° C. to 650° C. for 3 h to 8 h.

10. A lithium-ion battery, comprising the ternary cathode material of claim 1.
